(19) United States
(12) Patent Application Publication
(10) Pub. No.: US 2005/0229405 A1
(43) Pub. Date: Oct. 20, 2005

(54) Utensil for cutting food into child-size bites

(76) Inventors: William S. Endres, Leawood, KS (US); Mark T. Krasne, Kansas City, MO (US); Wesley A. Endres, Overland Park, KS (US); Duane K. Smith, Shawnee, KS (US); W. Eric Endres, Olathe, KS (US)

Correspondence Address: Hovey Williams LLP, Suite 400, 2405 Grand Blvd., Kansas City, MO, 64108, US

(21) Appl. No.: 10/824,137

(22) Filed: Apr. 14, 2004

(51) Int. Cl. B26B 3/00

(52) U.S. Cl. 30/305

(57) ABSTRACT

The utensil comprises a generally disc-shaped body having a plurality of laterally spaced apart cutting blades that project downwardly from the underside of the body. Lowermost, generally horizontally extending cutting edges on the blades are pushed into and through the food in a severing action when the body is placed in the palm of the user's hand and pressed downwardly into the food. Preferably, the top wall of the body is gently dome-shaped to be complementally received by the palm of the hand. Repeated pressing of the blades down into the food product at different rotative positions yields a crisscross cutting pattern that severs the food product into numerous small pieces, the final size of which depends upon the number of crisscross cutting strokes employed by the user. A preferred embodiment includes a central button in the top of the utensil that may be depressed to advance a stripping plate along the knife blades for dislodging any food pieces that may have been trapped between the blades. A cup-shaped cover may be quickly and easily attached to the bottom of the utensil to enclose and protectively house the blades.

### TECHNICAL FIELD

This invention relates to food cutting utensils and, more particularly to, a device that can be conveniently used to quickly and easily cut up adult-size servings of food into child-size bites.

### BACKGROUND AND SUMMARY

Parents of small children typically use knives and forks to cut food into smaller child-size bites. This can be a tedious and time-consuming task, particularly when there are several children who need immediate attention, or time is otherwise of the essence.

The present invention relates to a simple, quick, and easy-to-use hand tool that replaces traditional utensils for cutting up children's food into small pieces. In a preferred form, the invention comprises a hand-held device having a plurality of laterally spaced blades that project downwardly from a gripping body of the tool for penetrating and severing the food into smaller pieces when the tool is pressed down into the food. Repeated applications of the tool at crisscrossing cut angles results in further reduction of particle size.

In one preferred form of the invention, the blades are mounted on a palm-size, generally circular body and project downwardly therefrom so that the blades can be pressed into the food by grasping the body in the palm of the user's hand and applying a simple straight downward pressing action. Preferably, the top of the body is gently dome-shaped so as to fit comfortably into the palm and to facilitate the application of cutting pressure in repeated, crisscross cutting strokes.

Preferably, the utensil is provided with a spring-loaded stripper plate actuated by a depressible button on the top of the utensil. When the button is depressed, the stripper moves downwardly along the parallel blades, dislodging any food segments that may have been trapped between the blades. A protective, cup-like cover may be quickly and easily snapped or threaded onto the lower half of the utensil to fully house and cover the blades between uses.

### BRIEF DESCRIPTION OF THE DRAWINGS

FIG. 1 is a top isometric view of a food cutting utensil incorporating the principles of the present invention.

FIG. 2 is a bottom isometric view thereof rotated approximately 90° from the position of FIG. 1;

FIG. 3 is an exploded isometric view of the utensil showing also an optional blade cover as a part of the exploded combination;

FIG. 4 is a side elevational view of the utensil with the cover installed and partially broken away;

FIG. 5 is a vertical cross-sectional view through the utensil taken substantially along line 5-5 of FIG. 4 with the cover installed; and

FIG. 6 is a cross-sectional view of the utensil similar to FIG. 5 but with the knife cover removed and the stripper button depressed to illustrate the way in which the stripper plate moves downwardly along the knife blades to dislodge any pieces that may have become wedged between the blades.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

The utensil 10 comprises a generally disc-shaped body 12 having a plurality of generally flat, laterally spaced cutting blades 14 projecting downwardly from the bottom thereof and disposed in side-by-side relationship to one another. Body 12 is essentially hollow and comprises an open bottom shell 16 preferably molded from a synthetic resinous material and a circular floor 18 preferably constructed from a suitable metallic material. Preferably, shell 16 has a light, texturized plastic coating (not shown) to facilitate gripping and handling of utensil 10 during use.

Shell 16 has an annular top wall 20 that is slightly convexly arched so as to yield a gentle dome shape to the top of body 12. A circular outer edge 22 of shell 16 is gently rounded in a vertical sense to avoid the presentation of a sharp edge that would be uncomfortable when gripped by the hand of a user. A circumferentially extending, somewhat inwardly tapering and vertically rounded skirt 24 depends from edge 22 and terminates at its lower periphery in a circular lower edge 26 that defines a circular opening 28 presenting the open bottom of shell 16. Lower edge 26 is stepped to provide a seat for floor plate 18, which may be secured to such seat using any suitable means such as, for example, an adhesive or merely a tight, interference fit.

Shell 16 is also provided with a centrally disposed well 30 defined by a cylindrical interior wall 32 depending from top wall 20 and integrally joined therewith. Interior wall 32 extends downwardly into the opening 28 and is provided at its lowermost extremity with a plurality of circumferentially spaced mounting tabs 34 (FIGS. 3, 5 and 6) that are tightly received within corresponding slots 36 (FIG. 3) in the floor plate 18.

In the illustrated embodiment, a total of eight blades 14 are utilized. Blades 14 extend in parallel relationship to one another in vertical planes and traverse the circle defined by the circular floor plate 18 generally as chords of such circle, although blades 14 do not extend entirely across the full dimension of plate 18 and terminate slightly inboard of the circular edge of plate 18. Due to the circular nature of floor plate 18, the blades 14 are presented with progressively decreasing lengths in a horizontal direction moving from the center of floor plate 18 outwardly, there being a pair of central blades 14a of the same length on opposite sides of the center of plate 18, a second pair of slightly shorter blades 14b outboard of blades 14a, a third pair of still shorter blades 14c outboard of blades 14b, and a fourth pair of shortest blades 14d outboard of blades 14c.

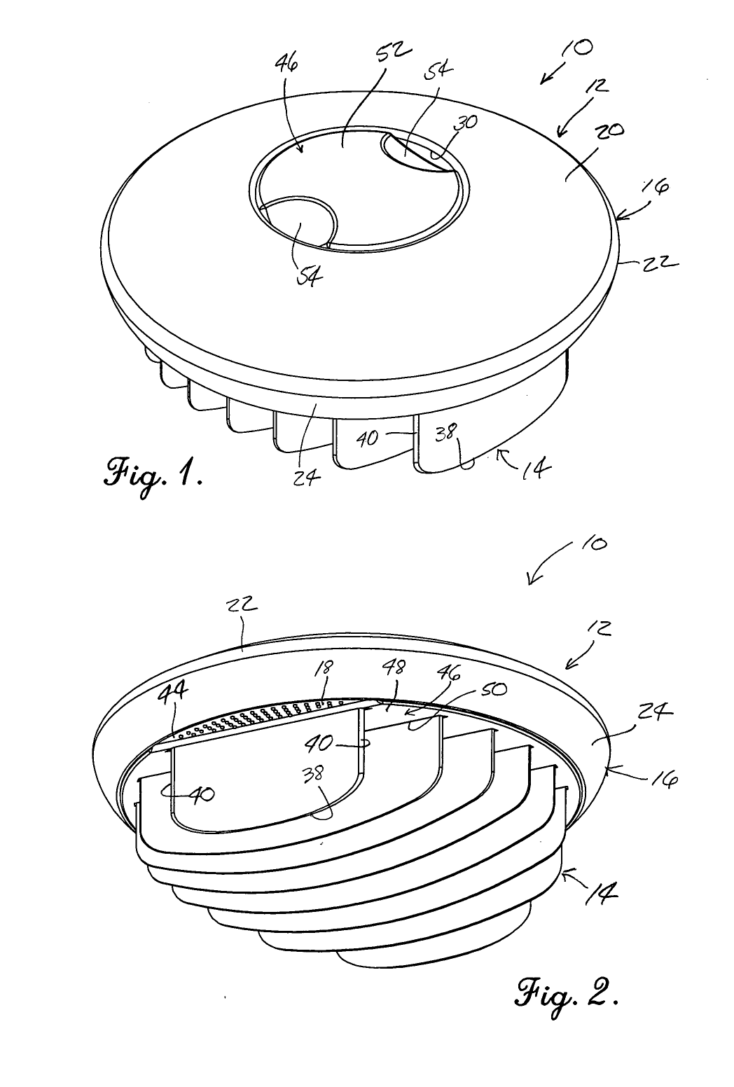

The lowermost extremities of blades 14 present sharp cutting edges 38 that extend generally horizontally but are preferably slightly convexly curved. At their opposite end extremities, cutting edges 38 join with upright, unsharpened end edges 40. As illustrated in FIGS. 2, 5 and 6, a pair of oppositely disposed sectors 44 of plate 18 immediately outboard of outer blades 14d are roughened, such as through the provision of downwardly projecting nibs, to facilitate gripping of utensil 10 with both hands during dislodgement of food pieces between blades 14 as hereinafter explained in more detail.

In a preferred embodiment of the invention, utensil 10 also includes a stripper broadly denoted by the numeral 46 for dislodging any food pieces that might become trapped between blades 14 during use. Preferably, stripper 46 comprises a generally flat stripping plate 48 disposed immediately below plate 18 and moveable downwardly along the length of blades 14 in a stripping action. Although not illustrated as such in the drawings, stripping plate 48 is preferably slightly convex. Stripping plate 48 is generally circular with a diameter that matches that of floor plate 18, except that stripping plate 48 has diametrically opposed, squared offends that reveal and expose the gripping sectors 44 of floor plate 18.

Stripping plate 48 is provided with eight clearance slots 50 that correspond in position and length to blades 14 so as to receive and clear such blades. Thus, slots 50 permit stripping plate 48 to be shifted between a raised, standby position in FIG. 5 and a lowered stripping position in FIG. 6.

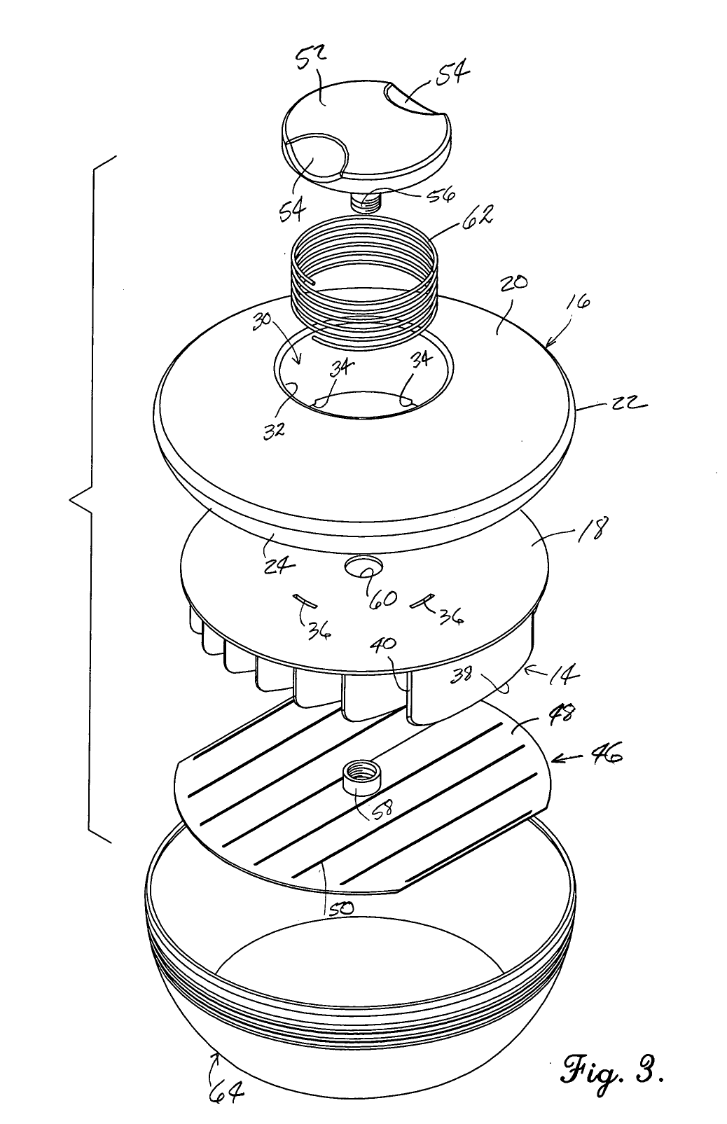

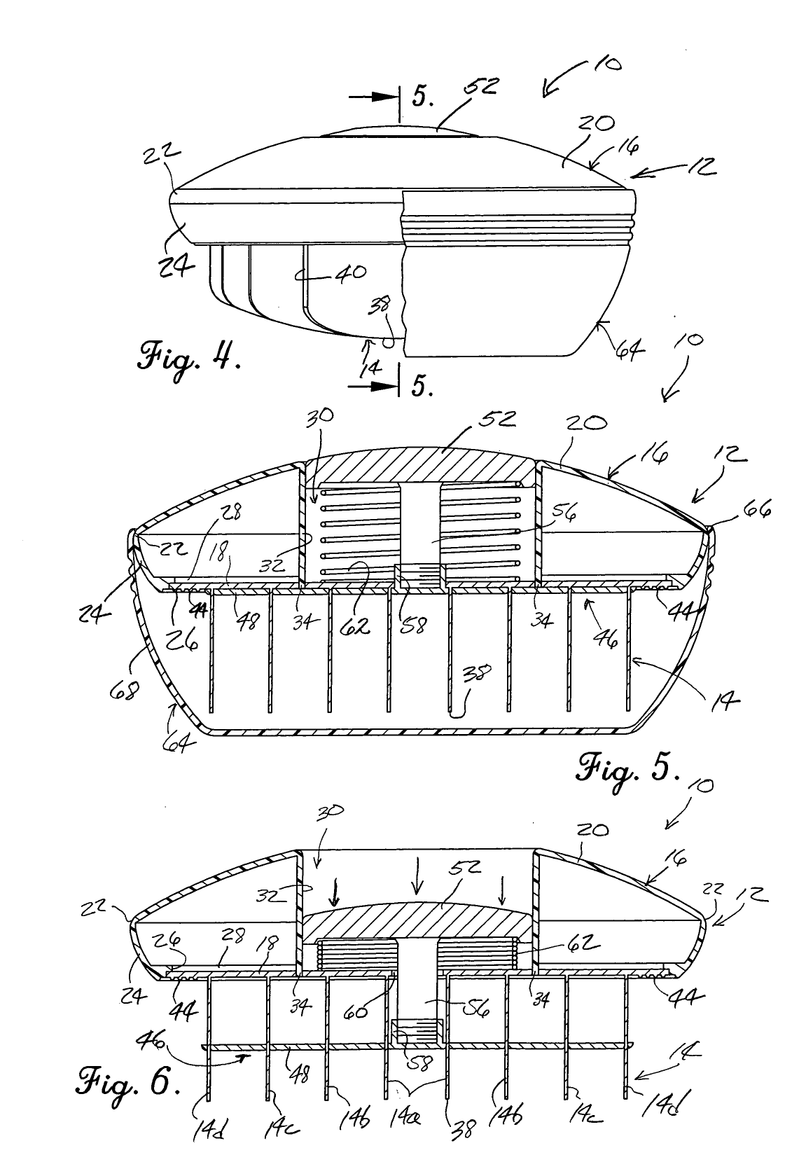

To facilitate actuation of stripping plate 48, an actuator button 52 is operably coupled with plate 48 and comprises part of stripper 46. Preferably, button 52 is arranged at the top, center of shell 16 and operates within well 32. Preferably, the upper surface of button 52 is convexly arched to the same degree as top wall 20 of shell 16 such that button 52 lies generally flush with the surface of top wall 20 when button 52 is in its raised position of FIGS. 1, 4 and 5. A pair of diametrically opposed, concave manipulating depressions 54 are formed in the top surface of button 52.

Button 52 is operably coupled with stripping plate 48 by a stud 56 projecting integrally downwardly from the bottom of button 52 and threadably received at its lower end by an upwardly extending, internally threaded hub 58 in the center of stripping plate 48. Hub 58 projects upwardly through a clearance hole 60 in floor plate 18. A coiled compression spring 62 encircles stud 56 and is trapped between the underside of button 52 and the top surface of floor plate 18 to yieldably bias button 52 toward its raised position. Upward movement of button 52 is limited by engagement of stripping plate with the bottom side of floor plate 18.

As illustrated in FIGS. 3, 4 and 5, utensil 10 may optionally include a cup-shaped cover 64 that snaps onto, or is quarter-turn threaded onto, the shell 16 to totally and protectively enclose blades 14. Preferably, cover 64, like shell 16, is molded from a suitable synthetic resinous material. In one embodiment, cover 64 is provided with a generally radially inwardly extending, enlarged bead 66 at the uppermost extremity of its sidewall 68 that snaps yieldably over circular outer edge 22 of shell 16 when cover 64 is installed to yieldably retain cover 64 in place. Alternatively, cover 64 may be provided at its upper edge extremity with quarter-turn internal threads (not shown) that are adapted to mesh with quarter-turn external threads (not shown) on edge 22 of shell 16 for retaining cover 64 in place.

Utensil 10 is used by first removing cover 64 and then grasping body 12 in such a manner that the user's fingers grip outer edge 22 while top wall 20 is received within the palm of the user's hand. The utensil may then be pressed straight down into the food, such as for example a chicken fillet, with the blades 14 entering into the food. While a straight line pressing motion may be completely adequate to make the desired cuts, it may also be appropriate in some circumstances to slightly rock the utensil back and forth along the contoured knife edges 38 to completely sever through the food item. Then, lifting the utensil upwardly a short distance and rotating it in a horizontal plane through a short arc, the user may re-align the blades 14 in a crossing pattern relative to the just completed cuts. A second downward pressing action thus causes knives 14 to cut the previously prepared strips into smaller pieces or segments. If further size reduction of the food pieces is desired, the device may be rotated again within a horizontal plane to another position and pressed back down into the food pieces. This quick, repeated crisscrossing pattern enables the user to quickly and easily cut a fairly large serving into any number of smaller, child-size bites.

If pieces of the cut-up food become lodged between blade 14 at any time during this process, the body 12 may be grasped in both hands with the fingers wrapped under the edge of the body and into engagement with the roughened portions 44 of floor plate 18. Then, using both thumbs, actuator button 52 may be pressed to advance stripping plate 48 along the blades 14 to push any food pieces from between blades 14. When finished cutting, cover 64 may be quickly replaced so as to safely enclose blades 14, permitting the utensil to be stored in any convenient locations such as, for example, the user's purse or bag.

Utensil 10 may be easily cleaned using detergent and water as with any other kitchen utensil. Additionally, if desired, utensil 10 may be disassembled by placing the thumb and index finger into depressions 54 on button 52 and then rotating button 52 relative to stripper plate 48 in the appropriate direction to unscrew stud 56 from hub 58. Once button 52 is removed, spring 62 and stripper plate 48 may be likewise disassembled from the device for any separate cleaning that may be desired.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. A food cutting utensil comprising:
a body adapted to be manually grasped; and
a plurality of elongated, laterally spaced apart cutting blades projecting downwardly from the body and presenting lowermost, generally horizontally extending cutting edges for severing food into pieces when the utensil is pressed downwardly into the food.

2. A food cutting utensil as claimed in claim 1,
said body having a generally convexly rounded top.

3. A food cutting utensil as claimed in claim 2,
said top of the body being generally dome-shaped with a circular outer periphery.

4. A food cutting utensil as claimed in claim 1,
said cutting edges being slightly convexly curved.

5. A food cutting utensil as claimed in claim 1,
further comprising a stripper selectively shiftable downwardly between the blades for dislodging food pieces from between the blades.

6. A food cutting utensil as claimed in claim 5,
said stripper comprising a plate having a plurality of clearance slots receiving said blades,
said stripper further comprising a depressible actuator secured to said plate and accessible from a top of the body for shifting the plate downwardly along the blades when the actuator is depressed.

7. A food cutting utensil as claimed in claim 6,
said stripper further comprising a spring yieldably biasing the actuator toward an undepressed position.

8. A food cutting utensil as claimed in claim 7,
said actuator including a manually depressible button.

9. A food cutting utensil as claimed in claim 8,
said body having a top that is generally circular in top plan,
said button being located substantially in the center of the top.

10. A food cutting utensil as claimed in claim 9,
said top being generally dome-shaped.

11. A food cutting utensil as claimed in claim 1,
said blades being substantially parallel to one another.

12. A food cutting utensil as claimed in claim 1,
further comprising a cover detachably secured to the body in covering relationship to said blades.
